(19) United States
(12) Patent Application Publication
(10) Pub. No.: US 2015/0236897 A1
(43) Pub. Date: Aug. 20, 2015

(54) NETWORK APPARATUS FOR USE IN CLUSTER SYSTEM

(71) Applicant: Bigtera Limited, Mongkok (HK)

(72) Inventors: Jian-Ying Chen, Taipei City (TW); Tsung-Lin Yu, Taipei City (TW)

(73) Assignee: Bigtera Limited, Mongkok (HK)

(21) Appl. No.: 14/184,822

(22) Filed: Feb. 20, 2014

(51) Int. Cl. H04L 12/24; H04W 40/32

(52) U.S. Cl. CPC H04L 41/0668; H04W 40/32

(57) ABSTRACT

A first network apparatus for use in a cluster system is provided. A second network apparatus administers the first network apparatus and the at least one third network apparatus. The first network apparatus comprises a transceiver, a storage unit and a processor. The transceiver is configured to connect with the second network apparatus and the at least one third network apparatus, and to receive status information of the at least one third network apparatus. The storage is configured to store the status information. The processor is configured to determine that the second network apparatus fails in the cluster system, and to administer the at least one third network apparatus according to the status information

### CROSS-REFERENCES TO RELATED APPLICATIONS

Not applicable.

### BACKGROUND OF THE INVENTION

1. Field of the Invention

The present invention relates to a network apparatus for use in a cluster system; more specifically, the network apparatus of the present invention take over to administer the other network apparatus after the original administrator fails.

2. Descriptions of the Related Art

In conventional network cluster management, a management server is needed for managing the network nodes of a cluster system. More specifically, in the cluster system, the management server connects to the network nodes and receives all the data transmitted from the network nodes. After receiving the data from the network nodes, the management server then integrates the data and provides the data to the applications or the users for later use.

However, there are some serious problems in the cluster system described above. First, since the network nodes of the cluster should be managed by the management server, the cluster will be crashed when the management server fails. Second, the efficiency of the whole cluster system depends on the performance of the management server since all data of the cluster is needed to be processed by the management server. Third, adding or removing network nodes in the cluster must be done by the management server, which increases the network work loading of the management server heavily.

Accordingly, an urgent need exists in the art to develop a new architecture for the cluster system for improving the defects of the conventional one.

### SUMMARY OF THE INVENTION

The primary objective of this invention is to provide a first network apparatus for use in a cluster system. The cluster system comprises a second network apparatus and at least one third network apparatus. The second network apparatus administers the first network apparatus and the at least one third network apparatus. The first network apparatus comprises a transceiver, a storage unit and a processor.

The transceiver is configured to connect with the second network apparatus and the at least one third network apparatus of the cluster system, and to receive status information of the at least one third network apparatus from the at least one third network apparatus. The storage is configured to store the status information. The processor is configured to determine that the second network apparatus fails in the cluster system, and to administer the at least one third network apparatus according to the status information

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of the cluster system according to the first embodiment of the present invention;

FIG. 1B is a block diagram of the first network apparatus according to the first embodiment of the present invention;

FIG. 2A is a schematic view of the cluster system according to the second embodiment of the present invention;

FIG. 2B is a block diagram of the first network apparatus according to the second embodiment of the present invention;

### DESCRIPTION OF THE PREFERRED EMBODIMENT

In the following description, the present invention will be explained with reference to embodiments thereof. However, these embodiments are not intended to limit the present invention to any environment, applications or implementations described in these embodiments. Therefore, description of these embodiments is only for purpose of illustration rather than to limit the present invention. In the following embodiments and the attached drawings, elements unrelated to the present invention are omitted from depiction; and dimensional relationships among individual elements in the following attached drawings are illustrated only for ease of understanding, but not to limit the actual scale.

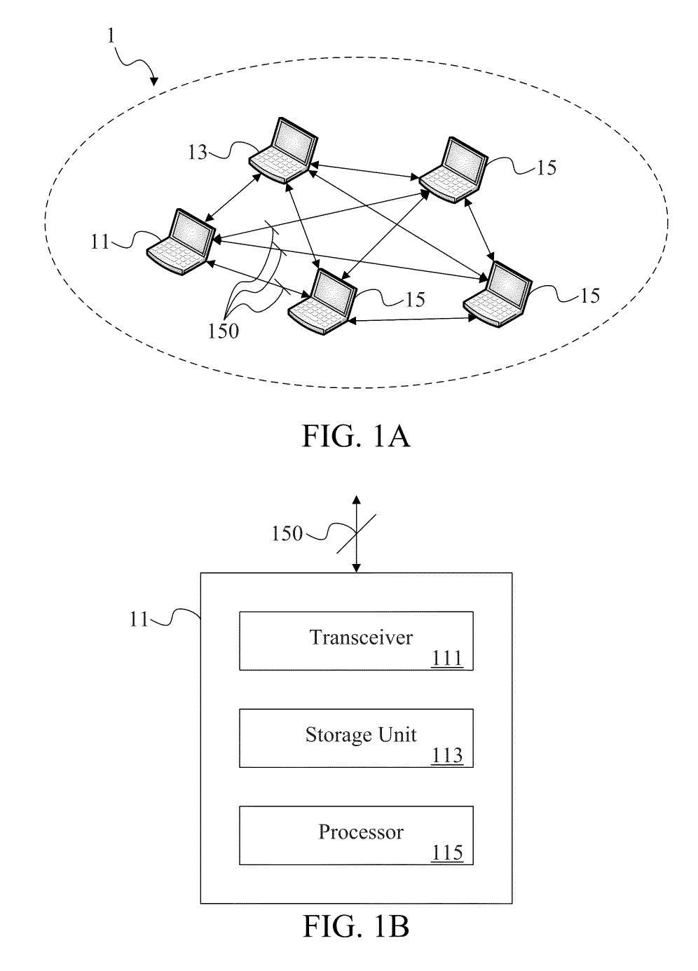

Please refer to FIGS. 1A and 1B. FIG. 1A is a schematic view of a cluster system 1 according to a first embodiment of the present invention. The cluster system 1 comprises a first network apparatus 11, a second network apparatus 13 and at least one third network apparatus 15 (There are three third network apparatus 15 in the first embodiment), and the second network apparatus 13 administers the first network apparatus 11 and the third network apparatus 15. FIG. 1B is a block diagram of the first network apparatus 11 according to the first embodiment of the present invention. The first network apparatus 11 comprises a transceiver 111, a storage unit 113 and a processor 115. Interactions between the individual elements will be further described hereinafter.

First, the transceiver 111 of the first network apparatus 11 connects with the second network apparatus 13 and the third network apparatus 15 of the cluster system 1. Accordingly, the first network apparatus 11 is administered by the second network apparatus 13 and the transceiver 111 of the first network apparatus 11 is capable of receiving status related information of its neighbor nodes which are the third network apparatus 15.

In other words, the transceiver 111 of the first network apparatus 11 receives status information 150 of the third network apparatus 15 from the third network apparatus 15, and then the storage unit 113 stores the status information 150 of the third network apparatus 15 for later use. Then, since the status information 150 of the third network apparatus 15 of the cluster system 1 are stored in the first network apparatus 11, the first network apparatus 11 can take over to administer the third network apparatus 15 while the second network apparatus 13 fails or crashes in the cluster system 1.

More specifically, since the first network apparatus 11 is connecting with the second network apparatus 13, the processor 115 of the first network apparatus 11 determines that the second network apparatus 13 fails or crashes in the cluster system 1 when the first network apparatus 11 stop receiving any message from the second network apparatus 13. Accordingly, the processor 115 of the first network apparatus 11 then administers the third network apparatus 15 according to the status information 150 of the third network apparatus 15.

Therefore, even the original administrator, the second network apparatus 13, the cluster system 1 fails or crashes in the cluster system 1, the cluster system 1 still works well since the first network apparatus takes over the administration. It should be noted that, in the present invention, all the network apparatus of the cluster system are capable of storing of the status information of the neighbor nodes so that it is possible for all the network apparatus to take over the administration of the cluster system.

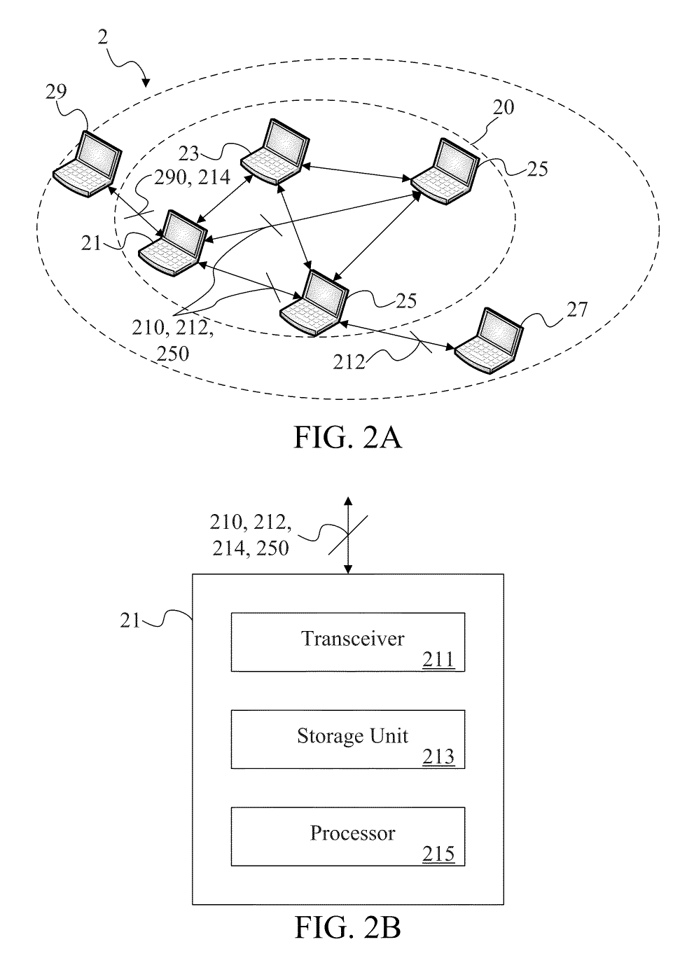

Please refer to FIGS. 2A and 2B. FIG. 2A is a schematic view of a cluster system 2 according to a second embodiment of the present invention. The cluster system 2 comprises a first network apparatus 21, a second network apparatus 23, a plurality of third network apparatus 25 and a fourth network apparatus 27. It should be noted that in the second embodiment, the first network apparatus 21, the second network apparatus 23 and the third network apparatus 25 are grouped in a neighbor group 20, and the second network apparatus 23 administers the first network apparatus 21 and the third network apparatus 25.

FIG. 2B is a schematic view of the first network apparatus 21 according to the second embodiment of the present invention. The first network apparatus 21 comprises a transceiver 211, a storage unit 213 and a processor 215. Interactions between the individual elements will be further described hereinafter.

Similarly, the transceiver 211 of the first network apparatus 21 connects with the second network apparatus 23 and the third network apparatus 25 of the cluster system 2. Accordingly, the first network apparatus 21 is administered by the second network apparatus 23 and the transceiver 211 of the first network apparatus 21 is capable of receiving status related information of its neighbor nodes which are the third network apparatus 25.

In other words, the transceiver 211 of the first network apparatus 21 receives status information 250 of the third network apparatus 25 from the third network apparatus 25, and then the storage unit 213 stores the status information 250 of the third network apparatus 25 for later use. Then, since the status information 250 of the third network apparatus 25 of the cluster system 2 are stored in the first network apparatus 21, the first network apparatus 21 can take over to administer the third network apparatus 25 while the second network apparatus 23 fails or crashes in the cluster system 2.

More specifically, since the first network apparatus 21 is connecting with the second network apparatus 23, the processor 215 of the first network apparatus 21 determines that the second network apparatus 23 fails or crashes in the cluster system 2 when the first network apparatus 21 stop receiving any message from the second network apparatus 23.

Accordingly, the processor 215 of the first network apparatus 21 then administers the third network apparatus 25 according to the status information 250 of the third network apparatus 15. Further, in order to administer the third network apparatus 25, the processor 215 of the first network apparatus 21 further transmits a control message 210 to the third network apparatus 25 by the transceiver 211.

It should be noted that, in the second embodiment, the fourth network apparatus 27 of cluster system 2 is not in the neighbor group 20, which means that fourth network apparatus 27 cannot communicate with the first network apparatus 21 directly. Therefore, if the first network apparatus 21 needs to administer the fourth network apparatus 27, the processor 215 further transmits a control message 212 to the fourth network apparatus 27 via the transceiver 211 through the third network apparatus 25 which connects with the fourth network apparatus 27 directly. Therefore, the first network apparatus 21 is capable of administering the fourth network apparatus 27.

Moreover, when a new network apparatus is needed to be added in the cluster system 2, the first network apparatus 21 can respond for becoming a neighbor of the new added network apparatus. Specifically, when a fifth network apparatus 29 is added in the cluster system 2, the fifth network apparatus 29 broadcasts an adding message 290.

Then, after the transceiver 211 of the first network apparatus 21 receives the adding message 290, the transceiver 211 of the first network apparatus 21 transmits a response message 214 to the fifth network apparatus 29 for connecting the fifth network apparatus 29. On the other hand, after receiving the response message 214, the fifth network apparatus 29 can select (or reject) the first network apparatus 21 as its neighbor.

According to the above descriptions, all the network apparatus based on the present invention can manages the other network apparatus in the cluster system while the original administrator fails or crashes since the network apparatus receive and store the status information of its neighbor nodes. Therefore, the defects of the conventional cluster system can be improved obviously.

The above disclosure is related to the detailed technical contents and inventive features thereof People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

What is claimed is:

1. A first network apparatus for use in a cluster system, the cluster system comprising a second network apparatus and at least one third network apparatus, the second network apparatus administering the first network apparatus and the at least one third network apparatus, the first network apparatus comprising:
a transceiver, being configured to connect with the second network apparatus and the at least one third network apparatus of the cluster system, and to receive status information of the at least one third network apparatus from the at least one third network apparatus;
a storage unit, being configured to store the status information;
a processor, being configured to determine that the second network apparatus fails in the cluster system, and to administer the at least one third network apparatus according to the status information.

2. The first network apparatus as claimed in claim 1, wherein the processor is further configured to administer the at least one third network apparatus via transmitting a control message by the transceiver.

3. The first network apparatus as claimed in claim 1, wherein the processor is further configured to administer at least one fourth network apparatus via transmitting a control message through the at least one third network apparatus by the transceiver.

4. The first network apparatus as claimed in claim 1, wherein the transceiver is further configured to receive an adding message from a fifth network apparatus, and to transmit a response message to the fifth network apparatus for connecting the fifth network apparatus.
